(19) United States
(12) Patent Application Publication
(10) Pub. No.: US 2023/0405469 A1
(43) Pub. Date: Dec. 21, 2023

(54) SYSTEMS AND METHODS FOR PROVIDING CROSS-PLATFORM DIGITAL ASSETS

(71) Applicant: Verizon Patent and Licensing Inc., Basking Ridge, NJ (US)

(72) Inventors: Dante J. Pacella, Charles Town, WV (US); Jeremy Germann, Piscataway, NJ (US)

(73) Assignee: Verizon Patent and Licensing Inc., Basking Ridge, NJ (US)

(21) Appl. No.: 17/807,903

(22) Filed: Jun. 21, 2022

(51) Int. Cl. A63F 13/69

(52) U.S. Cl. CPC A63F 13/69; A63F 13/792

(57) ABSTRACT

A system described herein may receive asset definition information indicating one or more attributes of an asset, which may include a real-world item or a digital asset, such as a non-fungible token (“NFT”). The system may provide the asset definition information to one or more digital platforms, such as gaming platforms, content streaming platforms, social media platforms, etc. The system may receive information indicating a particular entity having ownership of or access to the asset, and may indicating such entity to the digital platforms. The plurality of digital platforms may each provide a respective tokenized version of the asset to the particular entity based on the information indicating the particular entity having access to the asset. The tokenized versions of the asset may be automatically generated based on the asset definition information.

### BACKGROUND

Digital platforms, such as gaming applications, streaming music platforms, social media platforms, etc. may implement or include digital assets, such as character art, icons, sounds, etc. Some digital platforms may offer customization options to users, such as the ability to select or modify assets, obtain downloadable content (“DLC”), etc. Certain types of digital assets, such as non-fungible tokens (“NFTs”), may indicate ownership of, or access to, such digital assets.

### BRIEF DESCRIPTION OF THE DRAWINGS

FIG. 1 illustrates an example overview of one or more embodiments described herein;

FIG. 2 illustrates an example generation of one or more tokenized versions of an asset for multiple digital platforms, in accordance with some embodiments;

FIG. 3 illustrates an example of providing respective tokenized assets to a set of digital platforms, in accordance with some embodiments;

FIG. 4 illustrates an example of associating a particular set of assets with a particular ownership entity, in accordance with some embodiments;

FIG. 5 illustrates an example of indicating a respective ownership entity, associated with one or more assets, to a set of digital platforms, in accordance with some embodiments;

FIG. 6 illustrates an example of multiple digital platforms providing service, including respective tokenized versions of an asset, to an ownership entity associated with the asset, in accordance with some embodiments;

FIG. 7 illustrates an example process for providing cross-platform digital assets, in accordance with some embodiments;

FIG. 8 illustrates an example environment in which one or more embodiments, described herein, may be implemented;

FIG. 9 illustrates an example arrangement of a radio access network (“RAN”), in accordance with some embodiments; and

FIG. 10 illustrates example components of one or more devices, in accordance with one or more embodiments described herein.

### DETAILED DESCRIPTION OF EXAMPLE EMBODIMENTS

The following detailed description refers to the accompanying drawings. The same reference numbers in different drawings may identify the same or similar elements.

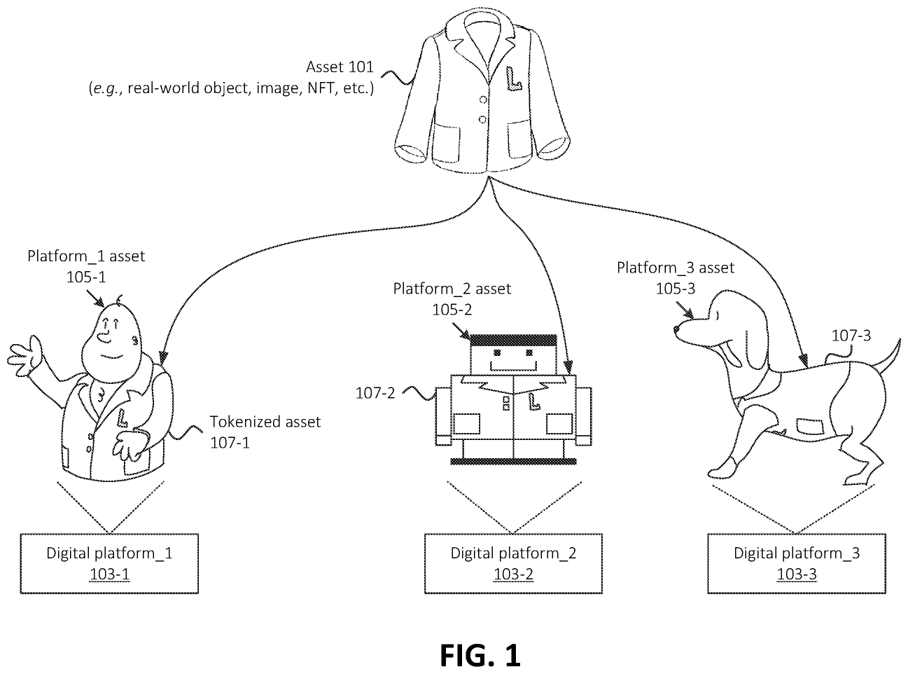

Embodiments described herein provide for the generation and providing of digital assets to multiple digital platforms. For example, as discussed below, a user may obtain ownership, access, licensing rights, etc. to a particular asset or digital asset, and tokenized versions of the obtained asset may be available for use on a variety of digital platforms, such as games, content streaming services, social media platforms, messaging platforms, etc. For example, as shown in FIG. 1, a particular asset 101 may be a real-world asset (e.g., an item of clothing, a hand-held object, an accessory, a portable electronic device, a tattoo, etc.) and/or a digital asset, such as an image or depiction of a real-world asset, an NFT, an audio file, or the like. In the example of FIG. 1, asset 101 may include a jacket or an image of a jacket. Tokenized versions of asset 101 may be generated (e.g., automatically generated, manually generated and/or reviewed, etc.) and provided to a variety of digital platforms 103, such as digital platforms 103-1 through 103-3. As discussed below, a user may obtain ownership, licensing rights, access, etc. to asset 101, and based on such ownership, licensing rights, etc., the user may have access to tokenized versions of asset 101 when receiving services from digital platforms 103.

Each digital platform 103 may be associated with a set of platform assets 105, which may include models (e.g., three-dimensional models), images, art, sprites, audio files, etc. In the context of a gaming platform for example, a particular platform asset 105 may be a character model, a vehicle model, a texture, or some other type of asset or object for a game provided by the gaming platform. Different digital platforms 103 may be associated with different art styles, asset fidelity attributes (e.g., polygon count, number of colors, color palettes, etc.), etc. Further, different digital platforms 103 may have different specifications or application programming interfaces (“APIs”) regarding how assets are handled or presented, such as model rigging attributes, handles, control points, etc.

In the example of FIG. 1, platform asset 105-1 (associated with digital platform 103-1) may be a character model in a first art style, platform asset 105-2 (associated with digital platform 103-2) may be a character model in a second art style, and platform asset 105-3 (associated with digital platform 103-3) may be a character model in a third art style. Further, platform assets 105-1 and 105-2 may be or may depict humanoid characters, while other platform assets 105 (e.g., platform asset 105-3) may be or may depict non-humanoid characters, such as dogs, cats, robots, aliens, etc. In accordance with embodiments described herein, tokenized versions of asset 101 (e.g., tokenized assets 107-1 through 107-3) may match the respective art styles or other parameters of digital platforms 103-1 through 103-3, while maintaining uniquely identifiable attributes of the original asset 101. In this manner, the same asset 101 may be depicted in widely varying styles across multiple digital platforms 103.

For example, in this example, asset 101 is a jacket with a lapel, two buttons on the right side of the jacket, a pocket on each side, and a logo (e.g., a shaded “L”) on the front left of the jacket. As shown, each tokenized asset 107 may differ from asset 101, in that tokenized assets 107 reflect the particular art styles or other attributes of respective digital platforms 103. However, each tokenized asset 107 may retain some or all of the attributes based on which asset 101 is identifiable, notwithstanding the respective modifications to match the respective art styles of digital platforms 103. For example, each tokenized asset 107 may also be a jacket with a lapel, two buttons on the right side of the jacket, a pocket on each side, and the same logo on the front left of the jacket.

In this manner, a user may be able to obtain ownership, licensing rights, etc. to a particular asset 101, and use tokenized versions of the asset across multiple platforms 103. In this manner, the robustness and utility of asset 101 may be enhanced, as well as enhancing the user experience of a user accessing digital platforms 103 that provide for the cross-platform asset techniques described herein.

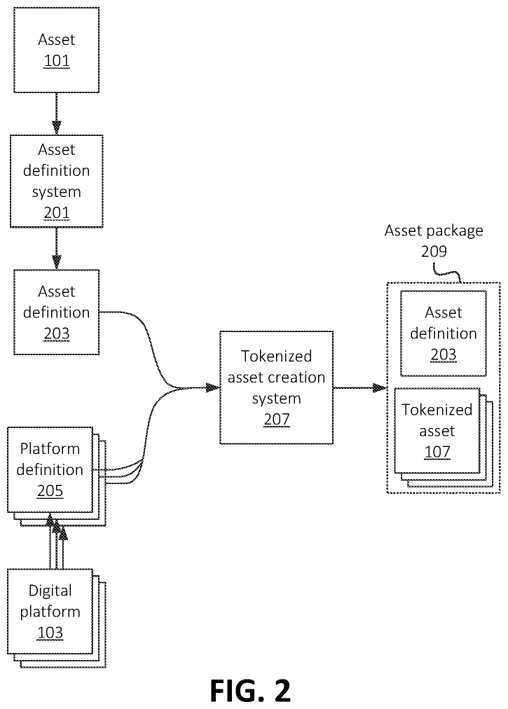

FIG. 2 illustrates an example of the creation of a set of tokenized assets 107 based on a given asset 101, where each tokenized asset 107 is generated in accordance with parameters, APIs, etc. associated with each digital platform 103 of a set of digital platforms 103. As shown, for example, asset definition system 201 may receive, identify, obtain, etc. asset 101. For example, asset definition system 201 may implement or include an API, portal, and/or other suitable interface via which asset definition system 201 is able to receive, identify, etc. asset 101. In some embodiments, asset definition system 201 may receive a representation or depiction of asset 101, such as an image or set of images of asset 101, a text description of asset 101, or other suitable representation or depiction of asset 101. For example, in the example where asset 101 is a real-world object, asset definition system 201 may receive images of the object, a make and/or model of the object, a set of specifications or attributes of the object, etc.

Asset definition system 201 may analyze asset 101 (and/or a representation, depiction, etc. of asset 101) to generate asset definition 203 associated with asset definition system 201. In some embodiments, asset definition system 201 may utilize one or more artificial intelligence/machine learning (“AI/ML”) techniques, image recognition techniques, pattern matching techniques, modeling techniques, or other suitable automated techniques in order to generate asset definition 203 based on an analysis of asset 101 (and/or a depiction thereof). As such, asset definition 203 may include one or more labels, classifications, identifiers, etc. associated with asset 101. Asset definition 203 may include a set of attributes, identifiers, parameters, features (e.g., visual features or other types of features), types, etc. of asset 101. For example, asset 101 may be able to be uniquely identified based on such attributes, identifiers, etc.

As further shown, each digital platform 103 of a set of digital platforms 103 may be associated with a respective platform definition 205. Each platform definition 205 may indicate attributes, constraints, parameters, etc. of assets that can be added, imported, provided, etc. to a respective digital platform 103. For example, a given platform definition 205 that is associated with a given digital platform 103 may specify graphical attributes or constraints, such as a color palette, polygon count, texture quality, etc. for assets that may be provided to digital platform 103. As another example, platform definition 205 may specify animation attributes or constraints, such as quantity or placement of control points, rigging, or other parameters associated with animating assets. As yet another example, platform definition 205 may specify deformation attributes or constraints, which may indicate how assets react to stimuli or events (e.g., the appearance of a jacket if rain falls on the jacket, the appearance of the jacket if the left sleeve is torn off, etc.). In some embodiments, platform definition 205 may include parameters indicating an art style associated with respective digital platform 103, such as proportions or measurements of character models or of character model features, types of shading or lighting techniques, etc. In some embodiments, platform definition 205 may include sample images, assets, etc. based on which features of the art style may be extrapolated, extracted, etc. (e.g., using AI/ML techniques, image recognition techniques, etc.). In some embodiments, platform definition 205 may include other suitable information based on which asset 101 (e.g., according to asset definition 203) may be adapted to a particular digital platform 103.

In some embodiments, asset definition 203 may include constraints, rules, etc. associated with particular assets 101. Such constraints may indicate particular categories, labels, attributes, etc. of particular assets 101 that must appear together (e.g., when presented as tokenized assets 107 on one or more respective digital platforms 103), assets 101 that may not appear together (e.g., when presented as tokenized assets 107 on one or more respective digital platforms 103), a subset of selectable colors or other options for tokenized assets 107 generated based on particular assets 101, etc. For example, asset definition 203 associated with a particular asset 101 may specify a first label (e.g., a first category, a first brand, etc.) associated with the particular asset 101. Asset definition 203 may further specify that tokenized asset 107, generated based on asset 101, may not be within a particular distance (e.g., 1 meter, 100 pixels, etc.) of another tokenized asset 107 that is associated with a second label (e.g., a second category, a second brand, etc.). As another example, asset definition 203 associated with a given asset 101 may specify that tokenized asset 107, generated based on the given asset 101, may be customized in one or more digital platforms 103 with the colors red, black, and green, but not blue (even if blue is a color that is otherwise offered in the one or more digital platforms 103). In some embodiments, asset definitions 203, associated with assets 101, may include other suitable types of rules, conditions, etc.

In some embodiments, such rules, constraints, conditions, etc. may be received from an entity that provides or is otherwise associated with a respective asset 101. In some embodiments, asset definition system 201 may automatically identify or generate such rules, constraints, conditions, etc. For example, asset definition system 201 may be configured with a framework based on which asset definition system 201 may automatically identify particular attributes of assets 101 which are associated with given rules, constraints, etc., and may apply such rules, constraints, etc. when determining that a given asset 101 has matching attributes.

As further shown, tokenized asset creation system 207 may receive asset definition 203 (e.g., from asset definition system 201 or some other suitable source) and one or more platform definitions 205 (e.g., from digital platforms 103 and/or some other suitable source), and may generate asset package 209 based on the received information. For example, in some embodiments, tokenized asset creation system 207 may use one or more AI/ML techniques, neural networks, deep learning, computer vision, or the like, in order to automatically generate tokenized assets 107 for each digital platform 103, of the set of digital platforms 103, based on respective platform definitions 205 and further based on asset definition 203 associated with asset 101. In this manner, tokenized asset creation system 207 may generate tokenized versions of asset 101, retaining the unique and/or identifiable qualities of asset 101, in a manner that matches the style, format, etc. of respective digital platforms 103.

In some embodiments, tokenized asset creation system 207 may include options or functionality to manually generate, modify, review, tweak, etc. tokenized assets 107 based on asset definition 203 and/or platform definitions 205. For example, tokenized asset creation system 207 may include an integrated development environment (“IDE”), a studio application, an API, and/or some other mechanism by which tokenized assets 107 may be manually generated or modified. Tokenized asset creation system 207 may generate and/or output asset package 209 associated with asset 101, which may include some or all of asset definition 203 and/or other information identifying asset 101 (e.g., a name, identifier, etc.), a thumbnail image of asset 101, metadata associated with asset 101, etc. Asset package 209 may also include tokenized assets 107 that were generated (e.g., by tokenized asset creation system 207) based on asset definition 203 and platform definitions 205 associated with respective digital platforms 103. In this manner, different assets 101 may be associated with different asset packages 209.

In some embodiments, tokenized asset creation system 207 may perform validation techniques, and may forgo generating respective tokenized assets 107 and/or may output one or more alerts based on performing such validation techniques. For example, tokenized asset creation system 207 may detect duplicate, pirated, “knock-off,” etc. assets 101 based on comparing attributes of a particular asset 101 (e.g., as specified by asset definition 203 associated with the particular asset 101) with attributes of another asset 101 (e.g., as specified by asset definition 203 associated with the other asset 101). Tokenized asset creation system 207 may perform a suitable similarity analysis to determine that the particular asset 101 and/or the other asset 101 are similar beyond a similarity threshold, and may forgo generating one or more tokenized assets 107 based on one or both assets 101. Additionally, or alternatively, tokenized asset creation system 207 may output one or more alerts indicating that assets 101 are similar (e.g., having at least a threshold measure of similarity).

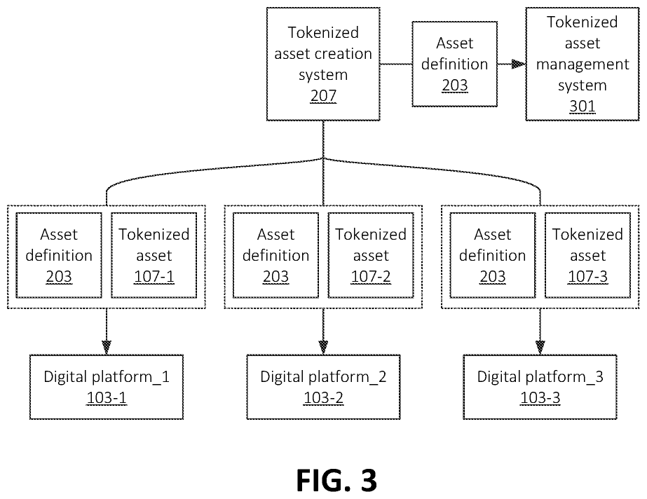

As shown in FIG. 3, tokenized asset creation system 207 may distribute asset package 209, and/or portions thereof, to respective digital platforms 103. For example, tokenized asset creation system 207 may provide, to digital platform 103-1, asset definition 203 and tokenized asset 107-1 associated with (e.g., generated based on) a particular asset 101. Tokenized asset creation system 207 may further provide asset definition 203 and tokenized asset 107-2 to digital platform 103-2, and may provide asset definition 203 and tokenized asset 107-3 to digital platform 103-3. In this manner, each digital platform 103 for which a respective tokenized asset 107 has been generated may receive its respective tokenized asset 107, and may also receive asset definition 203 (e.g., which may specify attributes of tokenized assets 107 and/or the asset 101 based on which tokenized assets 107 were generated, including rules or constraints associated with such tokenized assets 107, as discussed above).

In some embodiments, asset definition system 201 may provide asset definition 203 to one or more digital platforms 103. In such embodiments, such digital platforms 103 (and/or some other suitable device or system) may generate respective tokenized assets 107. That is, in some embodiments, creation of one or more tokenized assets 107 may be performed by digital platforms 103 or other devices or systems in lieu of, or in addition to, tokenized asset creation system 207.

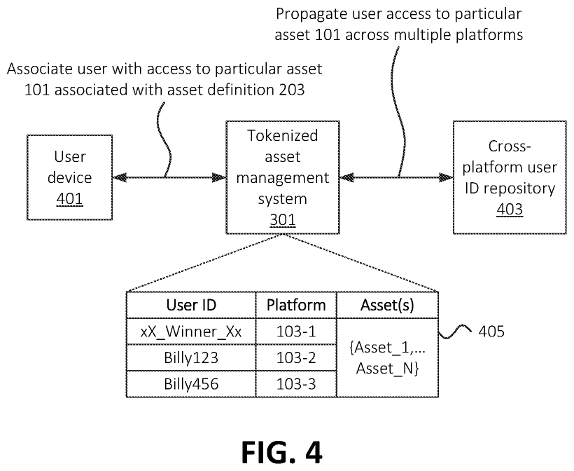

Further, tokenized asset creation system 207 may provide asset definition 203 to tokenized asset management system 301. Tokenized asset management system 301 may, as shown in FIG. 4, associate particular users or devices (e.g., user device 401) with a particular asset 101 and/or set of assets 101. For example, tokenized asset management system 301 may be communicatively coupled to a storefront, marketplace, rewards platform, digital content rights management or licensing system, etc., based on which a particular user or user device 401 may obtain access, ownership rights, etc. to one or more assets 101. As one example, a user may purchase a physical asset 101 (e.g., a jacket), which may include a Uniform Resource Locator (“URL”), a redemption code, a quick response (“QR”) code, etc. based on which the user may communicate with tokenized asset management system 301 (and/or some other device or system that is communicatively coupled to tokenized asset management system 301) in order to gain access to digital versions (e.g., tokenized assets 107) of asset 101. As another example, the user may purchase, trade for, or otherwise obtain a digital asset 101 (e.g., an NFT) and may communicate with tokenized asset management system 301 or some other device or system to indicate ownership or access rights to the digital asset 101. For example, the user may provide a digital signature (e.g., in accordance with one or more blockchain techniques) or otherwise verify ownership of the digital asset 101.

Tokenized asset management system 301 may also communicate with cross-platform user identifier repository 403, which may maintain and/or provide user or account identification information across multiple digital platforms 103. For example, the same user or user device 401 may be associated with different identifiers, such as user names, gamer tags, account names, etc. across multiple digital platforms 103. Tokenized asset management system 301 may accordingly maintain data structure 405, which may indicate particular assets 101 that a particular user or user device 401 is associated with ownership and/or access rights. For example, data structure 405 may include identifiers, attributes, hashes of respective asset definitions 203, etc. associated with one or more assets 101 owned by the user. Such owned assets 101 are represented here as “{Asset_1, . . . Asset_N}.” Data structure 405 may also indicate digital platforms 103 for which tokenized assets 107 have been generated based on the owned asset(s) 101, as well as a respective user identifier associated with the same user or user device 401 that owns asset(s) 101. As such, the example user identifiers shown in FIG. 4 (i.e., “xX_Winner_Xx,” “Billy123,” and “Billy 456”) may be associated with the same user or user device 401, but for different respective digital platforms 103 (i.e., digital platforms 103-1 through 103-3).

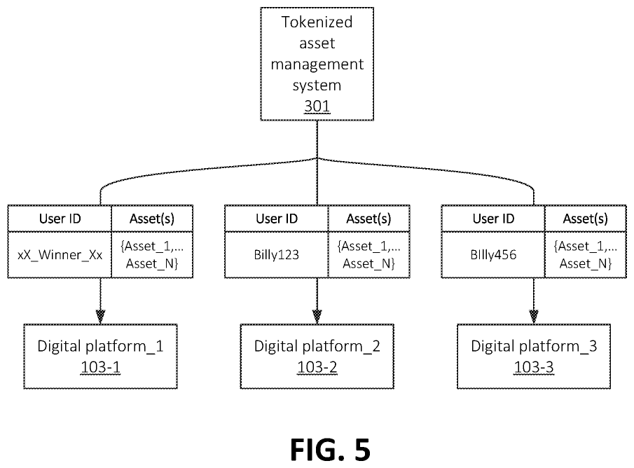

As further shown in FIG. 5, tokenized asset management system 301 may provide ownership, access, etc. information associated with respective user identifiers and asset identifiers to digital platforms 103 with which the respective user identifiers (e.g., as indicated in data structure 405) are associated. For example, tokenized asset management system 301 may indicate, to digital platform 103-1, that a user identifier that is associated with the asset owner as well as digital platform 103-1 (e.g., “xX_Winner_Xx,” referring to the above example) has ownership and/or access rights to a particular set of assets (e.g., “{Asset_1, . . . Asset_N}”). As noted above, such asset identifiers may be included in and/or may be based on asset definitions 203 associated with respective assets 101, which may be maintained by digital platforms 103 (e.g., as discussed above with respect to FIG. 3). As further shown, tokenized asset management system 301 may provide similar information to digital platforms 103-2 and 103-3. In this manner, the ownership, access, etc. of a single asset 101 (and, accordingly, the corresponding tokenized assets 107) may be propagated across different digital platforms 103 for the same user or user device 401.

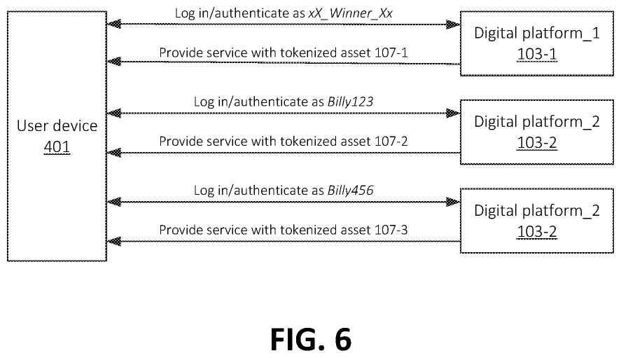

Thus, when receiving service from, or otherwise interacting with, respective digital platforms 103, the owner of asset 101 may receive access to platform-specific tokenized assets 107 that are associated with respective digital platforms 103. For example, as shown in FIG. 6, user device 401 may log in, participate in an authentication procedure, etc. with digital platform 103-1. Based on receiving or generating tokenized asset 107-1 (e.g., as discussed above with respect to FIG. 3), and further based on receiving asset ownership information provided to digital platform 103-1 (e.g., as discussed above with respect to FIG. 5), digital platform 103-1 may identify that user device 401 has ownership of and/or access to tokenized asset 107-1, and may provide service to user device 401, including providing access to tokenized asset 107-1. For example, digital platform 103-1 may indicate that tokenized asset 107-1 has been “unlocked” or is “available” for use in one or more services provided by digital platform 103-1. For instance, if digital platform 103-1 is associated with a game and tokenized asset 107-1 includes a wearable item for a game character, digital platform 103-1 may make the wearable item available for placing on a character in a character customization interface. As another example, if digital platform 103-1 is associated with a music streaming service, digital platform 103-1 may make tokenized asset 107-1 available as an icon or as a customization option for an avatar associated with user device 401.

As discussed above, certain tokenized assets 107 may be associated with rules, constraints, etc. When providing access to tokenized assets 107, respective digital platforms 103 may enforce, implement, etc. the rules, constraints, etc. For example, if a user of user device 401 wishes to place two different tokenized assets 107 on the same character, where one or both of the tokenized assets 107 are associated with constraints that would disallow placement on the same character (e.g., tokenized assets 107 may be associated with different brands or other categories), digital platform 103 may indicate an error and/or may otherwise not allow such placement. In this manner, rules, constraints, etc. particular assets 101 may be properly enforced, thus maintaining the integrity of assets 101.

As further shown in FIG. 6, digital platforms 103-2 and 103-3 may provide respective services to user device 401, which may include providing access to respective tokenized assets 107-2 and 107-3. In this manner, user device 401 may seamlessly receive access to tokenized versions of the same asset 101 across multiple different digital platforms 103.

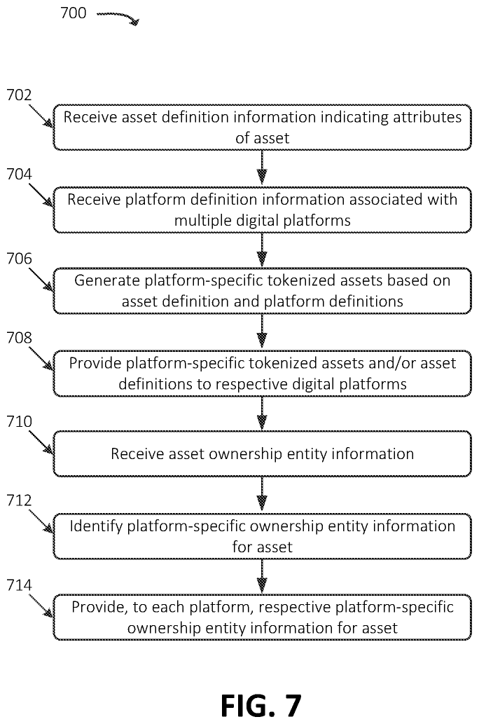

FIG. 7 illustrates an example process 700 for providing cross-platform digital assets. In some embodiments, some or all of process 700 may be performed by tokenized asset management system 301. In some embodiments, one or more other devices may perform some or all of process 700 in concert with, and/or in lieu of, tokenized asset management system 301, such as asset definition system 201, tokenized asset creation system 207, and/or some other device or system.

As shown, process 700 may include receiving (at 702) asset definition information indicating attributes of an asset. For example, as discussed above, asset definition 203 may be received from asset definition system 201 (e.g., which may automatically determine attributes of a given asset 101) and/or from some other source. Attributes of asset 101 may include, for example, features, metadata, characteristics, etc. based on which asset 101 may be uniquely identified. In some embodiments, attributes of asset 101 may include attributes, features, etc. based on which one or more digital representations of asset 101 (e.g., images, three-dimensional models, icons, etc.) may be generated.

Process 700 may further include receiving (at 704) platform definition information associated with multiple digital platforms. For example, as discussed above, platform definition 205 for a given digital platform 103 may include information regarding a color palette, art style, graphics quality, polygon count, etc. associated with digital platform 103.

Process 700 may additionally include generating (at 706) one or more platform-specific tokenized assets based on the asset definition information and the platform definition information. For example, as discussed above, tokenized asset creation system 207 may automatically generate one or more tokenized assets 107 based on asset definition 203 and/or respective platform definitions 205 associated with digital platforms 103.

Process 700 may also include providing (at 708) the platform-specific tokenized versions of the asset and/or the asset definition information to respective digital platforms 103. Additionally, or alternatively, as discussed above, digital platforms 103 may receive asset definition 203 information associated with asset 101, and may themselves generate respective tokenized assets 107. In this manner, each digital platform 103 may generate and/or receive a respective tokenized asset 107 that is based on the original asset 101, retaining the unique qualities of asset 101 (e.g., as indicated by asset definition 203).

Process 700 may further include receiving (at 710) asset ownership entity information. For example, as discussed above, a user or user device 401 may purchase, redeem, and/or otherwise gain ownership or access of asset 101.

Process 700 may additionally include identifying (at 712) platform-specific ownership entity information for the asset. For example, as discussed above, the same user, user device 401, etc. may be associated with different identifiers, accounts, etc. for different digital platforms 103. Cross-platform entity information may be used to link the ownership entity to such identifiers, accounts, etc. across digital platforms 103.

Process 700 may also include providing (at 714), to each digital platform, respective platform-specific ownership entity information for the asset. For example, each digital platform 103 may receive an indication of the respective identifier, account, etc. with which asset 101 as well as the respective digital platform 103 is associated. In this manner, each digital platform 103 may be able to link the received or generated tokenized asset 107, associated with asset 101, with the indicated ownership entity (e.g., user or user device 401) with which asset 101 is associated. Digital platforms 103 may accordingly be able to provide respective tokenized assets 107 to such ownership entity, thus providing the ownership entity with a cross-platform digital experience associated with asset 101.

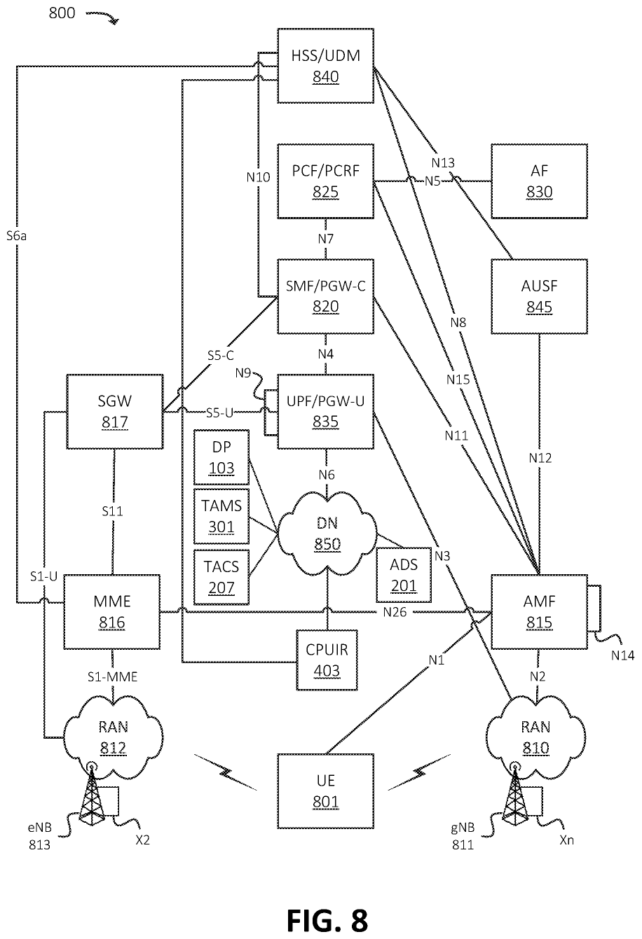

FIG. 8 illustrates an example environment 800, in which one or more embodiments may be implemented. In some embodiments, environment 800 may correspond to a Fifth Generation (“5G”) network, and/or may include elements of a 5G network. In some embodiments, environment 800 may correspond to a 5G Non-Standalone (“NSA”) architecture, in which a 5G radio access technology (“RAT”) may be used in conjunction with one or more other RATs (e.g., a Long-Term Evolution (“LTE”) RAT), and/or in which elements of a 5G core network may be implemented by, may be communicatively coupled with, and/or may include elements of another type of core network (e.g., an evolved packet core (“EPC”)). In some embodiments, portions of environment 800 may represent or may include a 5G core (“5GC”). As shown, environment 800 may include UE 801, RAN 810 (which may include one or more Next Generation Node Bs (“gNBs”) 811), RAN 812 (which may include one or more evolved Node Bs (“eNBs”) 813), and various network functions such as Access and Mobility Management Function (“AMF”) 815, Mobility Management Entity (“MME”) 816, Serving Gateway (“SGW”) 817, Session Management Function (“SMF”)/Packet Data Network (“PDN”) Gateway (“PGW”)-Control plane function (“PGW-C”) 820, Policy Control Function (“PCF”)/Policy Charging and Rules Function (“PCRF”) 825, Application Function (“AF”) 830, User Plane Function (“UPF”)/PGW-User plane function (“PGW-U”) 835, Unified Data Management (“UDM”)/Home Subscriber Server (“HSS”) 840, and Authentication Server Function (“AUSF”) 845. Environment 800 may also include one or more networks, such as Data Network (“DN”) 850. Environment 800 may include one or more additional devices or systems communicatively coupled to one or more networks (e.g., DN 850), such as one or more digital platforms 103, asset definition system 201, tokenized asset creation system 207, tokenized asset creation system 207, cross-platform user identifier repository 403, and/or one or more other devices or systems.

The example shown in FIG. 8 illustrates one instance of each network component or function (e.g., one instance of SMF/PGW-C 820, PCF/PCRF 825, UPF/PGW-U 835, UDM/HSS 840, and/or AUSF 845). In practice, environment 800 may include multiple instances of such components or functions. For example, in some embodiments, environment 800 may include multiple “slices” of a core network, where each slice includes a discrete and/or logical set of network functions (e.g., one slice may include a first instance of SMF/PGW-C 820, PCF/PCRF 825, UPF/PGW-U 835, UDM/HSS 840, and/or AUSF 845, while another slice may include a second instance of SMF/PGW-C 820, PCF/PCRF 825, UPF/PGW-U 835, UDM/HSS 840, and/or AUSF 845). The different slices may provide differentiated levels of service, such as service in accordance with different Quality of Service (“QoS”) parameters.

The quantity of devices and/or networks, illustrated in FIG. 8, is provided for explanatory purposes only. In practice, environment 800 may include additional devices and/or networks, fewer devices and/or networks, different devices and/or networks, or differently arranged devices and/or networks than illustrated in FIG. 8. For example, while not shown, environment 800 may include devices that facilitate or enable communication between various components shown in environment 800, such as routers, modems, gateways, switches, hubs, etc. Alternatively, or additionally, one or more of the devices of environment 800 may perform one or more network functions described as being performed by another one or more of the devices of environment 800. Devices of environment 800 may interconnect with each other and/or other devices via wired connections, wireless connections, or a combination of wired and wireless connections. In some implementations, one or more devices of environment 800 may be physically integrated in, and/or may be physically attached to, one or more other devices of environment 800.

UE 801 may include a computation and communication device, such as a wireless mobile communication device that is capable of communicating with RAN 810, RAN 812, and/or DN 850. UE 801 may be, or may include, a radiotelephone, a personal communications system (“PCS”) terminal (e.g., a device that combines a cellular radiotelephone with data processing and data communications capabilities), a personal digital assistant (“PDA”) (e.g., a device that may include a radiotelephone, a pager, Internet/intranet access, etc.), a smart phone, a laptop computer, a tablet computer, a camera, a personal gaming system, an Internet of Things (“IoT”) device (e.g., a sensor, a smart home appliance, a wearable device, a Machine-to-Machine (“M2M”) device, or the like), or another type of mobile computation and communication device. UE 801 may send traffic to and/or receive traffic (e.g., user plane traffic) from DN 850 via RAN 810, RAN 812, and/or UPF/PGW-U 835. In some embodiments, UE 801 may include, may be implemented by, may be communicatively coupled to, etc. user device 401.

RAN 810 may be, or may include, a 5G RAN that includes one or more base stations (e.g., one or more gNBs 811), via which UE 801 may communicate with one or more other elements of environment 800. UE 801 may communicate with RAN 810 via an air interface (e.g., as provided by gNB 811). For instance, RAN 810 may receive traffic (e.g., voice call traffic, data traffic, messaging traffic, signaling traffic, etc.) from UE 801 via the air interface, and may communicate the traffic to UPF/PGW-U 835, and/or one or more other devices or networks. Similarly, RAN 810 may receive traffic intended for UE 801 (e.g., from UPF/PGW-U 835, AMF 815, and/or one or more other devices or networks) and may communicate the traffic to UE 801 via the air interface.

RAN 812 may be, or may include, a LTE RAN that includes one or more base stations (e.g., one or more eNBs 813), via which UE 801 may communicate with one or more other elements of environment 800. UE 801 may communicate with RAN 812 via an air interface (e.g., as provided by eNB 813). For instance, RAN 810 may receive traffic (e.g., voice call traffic, data traffic, messaging traffic, signaling traffic, etc.) from UE 801 via the air interface, and may communicate the traffic to UPF/PGW-U 835, and/or one or more other devices or networks. Similarly, RAN 810 may receive traffic intended for UE 801 (e.g., from UPF/PGW-U 835, SGW 817, and/or one or more other devices or networks) and may communicate the traffic to UE 801 via the air interface.

AMF 815 may include one or more devices, systems, Virtualized Network Functions (“VNFs”), Cloud-Native Network Functions (“CNFs”), etc., that perform operations to register UE 801 with the 5G network, to establish bearer channels associated with a session with UE 801, to hand off UE 801 from the 5G network to another network, to hand off UE 801 from the other network to the 5G network, manage mobility of UE 801 between RANs 810 and/or gNBs 811, and/or to perform other operations. In some embodiments, the 5G network may include multiple AMFs 815, which communicate with each other via the N14 interface (denoted in FIG. 8 by the line marked “N14” originating and terminating at AMF 815).

MME 816 may include one or more devices, systems, VNFs, CNFs, etc., that perform operations to register UE 801 with the EPC, to establish bearer channels associated with a session with UE 801, to hand off UE 801 from the EPC to another network, to hand off UE 801 from another network to the EPC, manage mobility of UE 801 between RANs 812 and/or eNBs 813, and/or to perform other operations.

SGW 817 may include one or more devices, systems, VNFs, CNFs, etc., that aggregate traffic received from one or more eNBs 813 and send the aggregated traffic to an external network or device via UPF/PGW-U 835. Additionally, SGW 817 may aggregate traffic received from one or more UPF/PGW-Us 835 and may send the aggregated traffic to one or more eNBs 813. SGW 817 may operate as an anchor for the user plane during inter-eNB handovers and as an anchor for mobility between different telecommunication networks or RANs (e.g., RANs 810 and 812).

SMF/PGW-C 820 may include one or more devices, systems, VNFs, CNFs, etc., that gather, process, store, and/or provide information in a manner described herein. SMF/PGW-C 820 may, for example, facilitate the establishment of communication sessions on behalf of UE 801. In some embodiments, the establishment of communications sessions may be performed in accordance with one or more policies provided by PCF/PCRF 825.

PCF/PCRF 825 may include one or more devices, systems, VNFs, CNFs, etc., that aggregate information to and from the 5G network and/or other sources. PCF/PCRF 825 may receive information regarding policies and/or subscriptions from one or more sources, such as subscriber databases and/or from one or more users (such as, for example, an administrator associated with PCF/PCRF 825).

AF 830 may include one or more devices, systems, VNFs, CNFs, etc., that receive, store, and/or provide information that may be used in determining parameters (e.g., quality of service parameters, charging parameters, or the like) for certain applications.

UPF/PGW-U 835 may include one or more devices, systems, VNFs, CNFs, etc., that receive, store, and/or provide data (e.g., user plane data). For example, UPF/PGW-U 835 may receive user plane data (e.g., voice call traffic, data traffic, etc.), destined for UE 801, from DN 850, and may forward the user plane data toward UE 801 (e.g., via RAN 810, SMF/PGW-C 820, and/or one or more other devices). In some embodiments, multiple UPFs 835 may be deployed (e.g., in different geographical locations), and the delivery of content to UE 801 may be coordinated via the N9 interface (e.g., as denoted in FIG. 8 by the line marked “N9” originating and terminating at UPF/PGW-U 835). Similarly, UPF/PGW-U 835 may receive traffic from UE 801 (e.g., via RAN 810, SMF/PGW-C 820, and/or one or more other devices), and may forward the traffic toward DN 850. In some embodiments, UPF/PGW-U 835 may communicate (e.g., via the N4 interface) with SMF/PGW-C 820, regarding user plane data processed by UPF/PGW-U 835.

UDM/HSS 840 and AUSF 845 may include one or more devices, systems, VNFs, CNFs, etc., that manage, update, and/or store, in one or more memory devices associated with AUSF 845 and/or UDM/HSS 840, profile information associated with a subscriber. AUSF 845 and/or UDM/HSS 840 may perform authentication, authorization, and/or accounting operations associated with the subscriber and/or a communication session with UE 801.

DN 850 may include one or more wired and/or wireless networks. For example, DN 850 may include an Internet Protocol (“IP”)-based PDN, a wide area network (“WAN”) such as the Internet, a private enterprise network, and/or one or more other networks. UE 801 may communicate, through DN 850, with data servers, other UEs 801, and/or to other servers or applications that are coupled to DN 850. DN 850 may be connected to one or more other networks, such as a public switched telephone network (“PSTN”), a public land mobile network (“PLMN”), and/or another network. DN 850 may be connected to one or more devices, such as content providers, applications, web servers, and/or other devices, with which UE 801 may communicate.

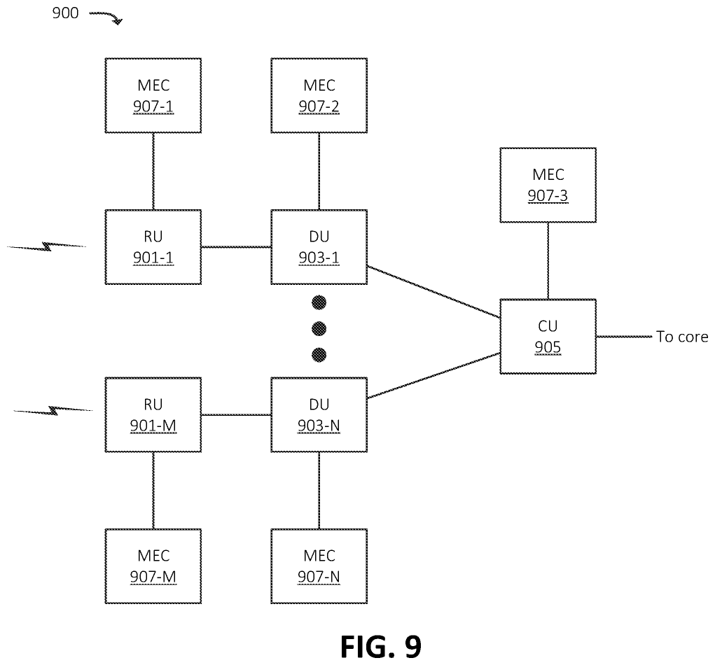

FIG. 9 illustrates an example Distributed Unit (“DU”) network 900, which may be included in and/or implemented by one or more RANs (e.g., RAN 810, RAN 812, or some other RAN). In some embodiments, a particular RAN may include one DU network 900. In some embodiments, a particular RAN may include multiple DU networks 900. In some embodiments, DU network 900 may correspond to a particular gNB 811 of a 5G RAN (e.g., RAN 810). In some embodiments, DU network 900 may correspond to multiple gNBs 811. In some embodiments, DU network 900 may correspond to one or more other types of base stations of one or more other types of RANs. As shown, DU network 900 may include Central Unit (“CU”) 905, one or more Distributed Units (“DUs”) 903-1 through 903-N (referred to individually as “DU 903,” or collectively as “DUs 903”), and one or more Radio Units (“RUs”) 901-1 through 901-M (referred to individually as “RU 901,” or collectively as “RUs 901”).

CU 905 may communicate with a core of a wireless network (e.g., may communicate with one or more of the devices or systems described above with respect to FIG. 8, such as AMF 815 and/or UPF/PGW-U 835). In the uplink direction (e.g., for traffic from UEs 801 to a core network), CU 905 may aggregate traffic from DUs 903, and forward the aggregated traffic to the core network. In some embodiments, CU 905 may receive traffic according to a given protocol (e.g., Radio Link Control (“RLC”)) from DUs 903, and may perform higher-layer processing (e.g., may aggregate/process RLC packets and generate Packet Data Convergence Protocol (“PDCP”) packets based on the RLC packets) on the traffic received from DUs 903.

In accordance with some embodiments, CU 905 may receive downlink traffic (e.g., traffic from the core network) for a particular UE 801, and may determine which DU(s) 903 should receive the downlink traffic. DU 903 may include one or more devices that transmit traffic between a core network (e.g., via CU 905) and UE 801 (e.g., via a respective RU 901). DU 903 may, for example, receive traffic from RU 901 at a first layer (e.g., physical (“PHY”) layer traffic, or lower PHY layer traffic), and may process/aggregate the traffic to a second layer (e.g., upper PHY and/or RLC). DU 903 may receive traffic from CU 905 at the second layer, may process the traffic to the first layer, and provide the processed traffic to a respective RU 901 for transmission to UE 801.

RU 901 may include hardware circuitry (e.g., one or more RF transceivers, antennas, radios, and/or other suitable hardware) to communicate wirelessly (e.g., via an RF interface) with one or more UEs 801, one or more other DUs 903 (e.g., via RUs 901 associated with DUs 903), and/or any other suitable type of device. In the uplink direction, RU 901 may receive traffic from UE 801 and/or another DU 903 via the RF interface and may provide the traffic to DU 903. In the downlink direction, RU 901 may receive traffic from DU 903, and may provide the traffic to UE 801 and/or another DU 903.

RUs 901 may, in some embodiments, be communicatively coupled to one or more Multi-Access/Mobile Edge Computing (“MEC”) devices, referred to sometimes herein simply as “MECs” 907. For example, RU 901-1 may be communicatively coupled to MEC 907-1, RU 901-M may be communicatively coupled to MEC 907-M, DU 903-1 may be communicatively coupled to MEC 907-2, DU 903-N may be communicatively coupled to MEC 907-N, CU 905 may be communicatively coupled to MEC 907-3, and so on. MECs 907 may include hardware resources (e.g., configurable or provisionable hardware resources) that may be configured to provide services and/or otherwise process traffic to and/or from UE 801, via a respective RU 901.

For example, RU 901-1 may route some traffic, from UE 801, to MEC 907-1 instead of to a core network (e.g., via DU 903 and CU 905). MEC 907-1 may process the traffic, perform one or more computations based on the received traffic, and may provide traffic to UE 801 via RU 901-1. In this manner, ultra-low latency services may be provided to UE 801, as traffic does not need to traverse DU 903, CU 905, and an intervening backhaul network between DU network 900 and the core network. In some embodiments, MEC 907 may include, and/or may implement, some or all of the functionality described above with respect to one or more digital platforms 103, asset definition system 201, tokenized asset creation system 207, tokenized asset management system 301, cross-platform user identifier repository 403, UPF 835, and/or one or more other devices, systems, VNFs, CNFs, etc.

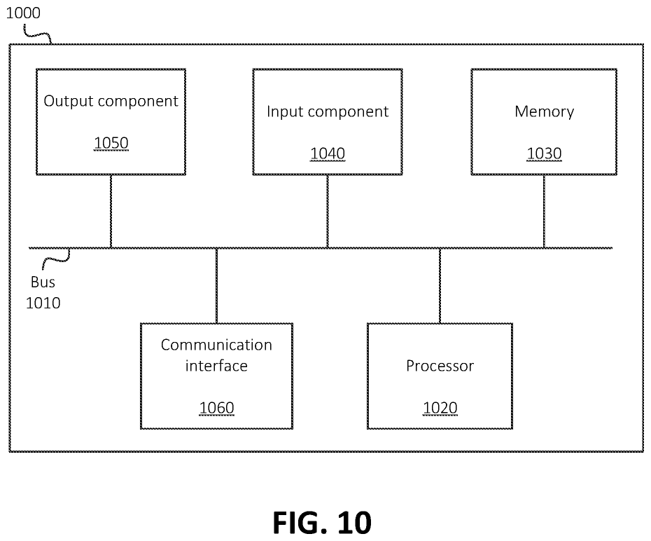

FIG. 10 illustrates example components of device 1000. One or more of the devices described above may include one or more devices 1000. Device 1000 may include bus 1010, processor 1020, memory 1030, input component 1040, output component 1050, and communication interface 1060. In another implementation, device 1000 may include additional, fewer, different, or differently arranged components.

Bus 1010 may include one or more communication paths that permit communication among the components of device 1000. Processor 1020 may include a processor, microprocessor, or processing logic that may interpret and execute instructions. In some embodiments, processor 1020 may be or may include one or more hardware processors. Memory 1030 may include any type of dynamic storage device that may store information and instructions for execution by processor 1020, and/or any type of non-volatile storage device that may store information for use by processor 1020.

Input component 1040 may include a mechanism that permits an operator to input information to device 1000 and/or other receives or detects input from a source external to 1040, such as a touchpad, a touchscreen, a keyboard, a keypad, a button, a switch, a microphone or other audio input component, etc. In some embodiments, input component 1040 may include, or may be communicatively coupled to, one or more sensors, such as a motion sensor (e.g., which may be or may include a gyroscope, accelerometer, or the like), a location sensor (e.g., a Global Positioning System (“GPS”)-based location sensor or some other suitable type of location sensor or location determination component), a thermometer, a barometer, and/or some other type of sensor. Output component 1050 may include a mechanism that outputs information to the operator, such as a display, a speaker, one or more light emitting diodes (“LEDs”), etc.

Communication interface 1060 may include any transceiver-like mechanism that enables device 1000 to communicate with other devices and/or systems. For example, communication interface 1060 may include an Ethernet interface, an optical interface, a coaxial interface, or the like. Communication interface 1060 may include a wireless communication device, such as an infrared (“IR”) receiver, a Bluetooth© radio, or the like. The wireless communication device may be coupled to an external device, such as a remote control, a wireless keyboard, a mobile telephone, etc. In some embodiments, device 1000 may include more than one communication interface 1060. For instance, device 1000 may include an optical interface and an Ethernet interface.

Device 1000 may perform certain operations relating to one or more processes described above. Device 1000 may perform these operations in response to processor 1020 executing software instructions stored in a computer-readable medium, such as memory 1030. A computer-readable medium may be defined as a non-transitory memory device. A memory device may include space within a single physical memory device or spread across multiple physical memory devices. The software instructions may be read into memory 1030 from another computer-readable medium or from another device. The software instructions stored in memory 1030 may cause processor 1020 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

For example, while series of blocks and/or signals have been described above (e.g., with regard to FIGS. 1-7), the order of the blocks and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

The actual software code or specialized control hardware used to implement an embodiment is not limiting of the embodiment. Thus, the operation and behavior of the embodiment has been described without reference to the specific software code, it being understood that software and control hardware may be designed based on the description herein.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A device, comprising:
one or more processors configured to:
receive asset definition information indicating one or more attributes of an asset;
provide the asset definition information to a plurality of digital platforms;
receive information indicating a particular entity having access to the asset; and
provide the information, indicating the particular entity having access to the asset, to the plurality of digital platforms,
wherein the plurality of digital platforms each provide a respective tokenized version of the asset to the particular entity based on the information indicating the particular entity having access to the asset.

2. The device of claim 1, wherein the one or more processors are further configured to:
automatically generate a plurality of tokenized versions of the asset, wherein each respective tokenized version of the asset is associated with a particular digital platform of the plurality of digital platforms.

3. The device of claim 2, wherein the one or more processors are further configured to:
provide, with the asset definition information, the respective tokenized version of the asset to each digital platform with which the tokenized version of the asset is associated.

4. The device of claim 2, wherein the one or more processors are further configured to:
receive attributes associated with each digital platform of the plurality of digital platforms, wherein automatically generating the plurality of tokenized versions of the asset includes generating, for each digital platform, a respective tokenized version of the asset further based on the attributes associated with the each digital platform.

5. The device of claim 1, wherein the one or more attributes of the asset include one or more visual features of the asset.

6. The device of claim 1, wherein the asset includes a non-fungible token (“NFT”).

7. The device of claim 1,
wherein the plurality of digital platforms include a gaming platform that includes one or more characters,
wherein the asset definition information indicates that the asset includes a wearable item, and
wherein the tokenized version of the asset includes, based on the asset definition information, a digital version of the wearable item that is wearable by the one or more characters of the gaming platform.

8. A non-transitory computer-readable medium, storing a plurality of processor-executable instructions to:
receive asset definition information indicating one or more attributes of an asset;
provide the asset definition information to a plurality of digital platforms;
receive information indicating a particular entity having access to the asset; and
provide the information, indicating the particular entity having access to the asset, to the plurality of digital platforms,
wherein the plurality of digital platforms each provide a respective tokenized version of the asset to the particular entity based on the information indicating the particular entity having access to the asset.

9. The non-transitory computer-readable medium of claim 8, wherein the plurality of processor-executable instructions further include processor-executable instructions to:
automatically generate a plurality of tokenized versions of the asset, wherein each respective tokenized version of the asset is associated with a particular digital platform of the plurality of digital platforms.

10. The non-transitory computer-readable medium of claim 9, wherein the plurality of processor-executable instructions further include processor-executable instructions to:
provide, with the asset definition information, the respective tokenized version of the asset to each digital platform with which the tokenized version of the asset is associated.

11. The non-transitory computer-readable medium of claim 9, wherein the plurality of processor-executable instructions further include processor-executable instructions to:
receive attributes associated with each digital platform of the plurality of digital platforms, wherein automatically generating the plurality of tokenized versions of the asset includes generating, for each digital platform, a respective tokenized version of the asset further based on the attributes associated with the each digital platform.

12. The non-transitory computer-readable medium of claim 8, wherein the one or more attributes of the asset include one or more visual features of the asset.

13. The non-transitory computer-readable medium of claim 8, wherein the asset includes a non-fungible token (“NFT”).

14. The non-transitory computer-readable medium of claim 8,
wherein the plurality of digital platforms include a gaming platform that includes one or more characters,
wherein the asset definition information indicates that the asset includes a wearable item, and
wherein the tokenized version of the asset includes, based on the asset definition information, a digital version of the wearable item that is wearable by the one or more characters of the gaming platform.

15. A method, comprising:
receiving asset definition information indicating one or more attributes of an asset;
providing the asset definition information to a plurality of digital platforms;
receiving information indicating a particular entity having access to the asset; and
providing the information, indicating the particular entity having access to the asset, to the plurality of digital platforms,
wherein the plurality of digital platforms each provide a respective tokenized version of the asset to the particular entity based on the information indicating the particular entity having access to the asset.

16. The method of claim 15, further comprising:
automatically generating a plurality of tokenized versions of the asset, wherein each respective tokenized version of the asset is associated with a particular digital platform of the plurality of digital platforms.

17. The method of claim 16, further comprising:
receiving attributes associated with each digital platform of the plurality of digital platforms, wherein automatically generating the plurality of tokenized versions of the asset includes generating, for each digital platform, a respective tokenized version of the asset further based on the attributes associated with the each digital platform.

18. The method of claim 15, wherein the one or more attributes of the asset include one or more visual features of the asset.

19. The method of claim 15, wherein the asset includes a non-fungible token (“NFT”).

20. The method of claim 15,
wherein the plurality of digital platforms include a gaming platform that includes one or more characters,
wherein the asset definition information indicates that the asset includes a wearable item, and
wherein the tokenized version of the asset includes, based on the asset definition information, a digital version of the wearable item that is wearable by the one or more characters of the gaming platform.
